(19) United States
(12) Patent Application Publication
(10) Pub. No.: US 2009/0013502 A1
(43) Pub. Date: Jan. 15, 2009

(54) Adjustable Handlebar Assembly for a Stand

(76) Inventor: Fu-Yuan CHENG, Taichung (TW)

Correspondence Address: Dr. BANGER SHIA, 102 Lindencrest Ct., Sugar Land, TX, 77479-5201, US

(21) Appl. No.: 11/777,284

(22) Filed: Jul. 13, 2007

(51) Int. Cl. B25G 1/04

(52) U.S. Cl. 16/429

(57) ABSTRACT

An adjustable handlebar assembly for a stand comprises a handlebar and a positioning assembly. The handlebar is rotatably mounted on the stand, and the positioning assembly serves to position the handlebar. The handlebar can be rotated to adjust its operation angle and can be positioned by the positioning assembly after rotating to a desired angle, so that the user can adjust the operation angle of the handlebar according to his own stature and habit, thus enhancing the convenience of use.

### BACKGROUND OF THE INVENTION

1. Field of the Invention

The present invention relates to a stand, and more particularly to an adjustable handlebar assembly for a stand.

2. Description of the Prior Art

A conventional movable stand, no matter it is used on a handcart, a stretcher, or a hammock, is usually provided with a handle for allowing the user to push. And a conventional handle 10 is shown in FIG. 1 and is fixed to a stand A. However, users with different statures or habits have different operation angles and heights. Since the handle 10 is fixed with respect to the stand A, its operation angle and height are unchangeable, only a few users can get use to it, and most of the users still feel it is inconvenient to use it. Therefore, it is important to invent a handle, which can overcome the abovementioned inconvenience of use and fit users of different statures.

The present invention has arisen to mitigate and/or obviate the afore-described disadvantages.

### SUMMARY OF THE INVENTION

The primary objective of the present invention is to provide an adjustable handlebar assembly for a stand, which utilizes a positioning assembly to position the handlebar, and after it is released from the fixed position, the handlebar can be adjusted to a desired angle, so that the user can adjust the operation angle of the handlebar according to his own stature and habit.

To achieve the above objective, an adjustable handlebar assembly for a stand in accordance with the present invention comprises a handlebar and a positioning assembly. The handlebar is pivotally mounted on the stand and provided with a positioning member, the positioning member is formed with at least one positioning portion. The positioning assembly is mounted on the stand by cooperating with the positioning member of the handlebar and includes a positioning seat and a limit subassembly for cooperating with the positioning portion of the handlebar to position the handlebar.

The handlebar can be rotated to adjust its operation angle and can be positioned by the positioning assembly after rotating to a desired angle, so that the user can adjust the operation angle of the handlebar according to his own stature and habit, thus enhancing the convenience of use.

In addition, the positioning portions of the positioning member of the handlebar can be in the form of a through hole, so that the control rod of the positioning assembly can be inserted in one of the positioning portions to position the handlebar.

### BRIEF DESCRIPTION OF THE DRAWINGS

FIG. 1 is a perspective view of a conventional handlebar for a stand;

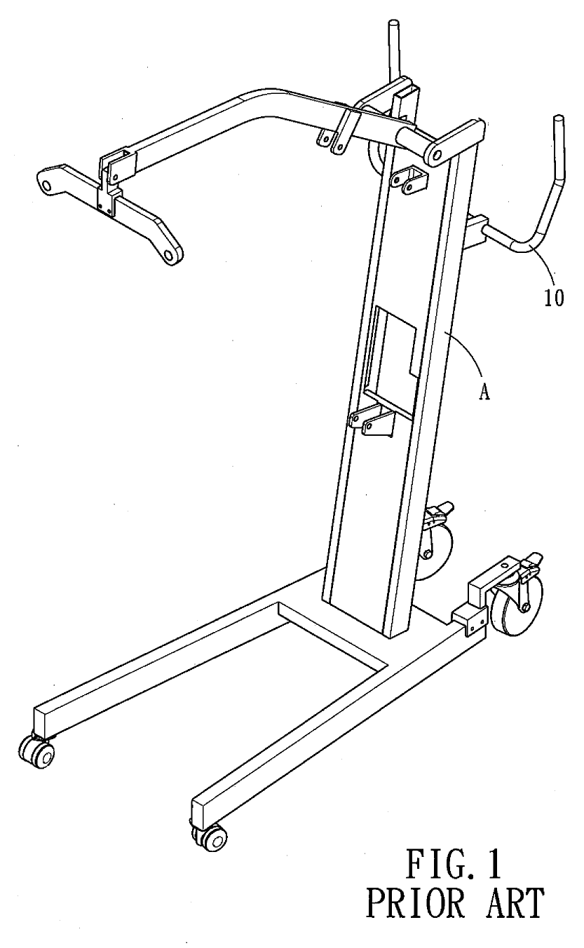

FIG. 2 is an exploded view of a handlebar assembly for a stand in accordance with a preferred embodiment of the present invention;

FIG. 3 is a cross sectional view of the handlebar assembly for a stand in accordance with the preferred embodiment of the present invention;

FIG. 4 is an illustrative view in accordance with the preferred embodiment of the present invention of showing that the handlebar is positioned in the fixed position; and

FIG. 5 is an illustrative view in accordance with the preferred embodiment of the present invention of showing that the handlebar is released from the fixed position.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

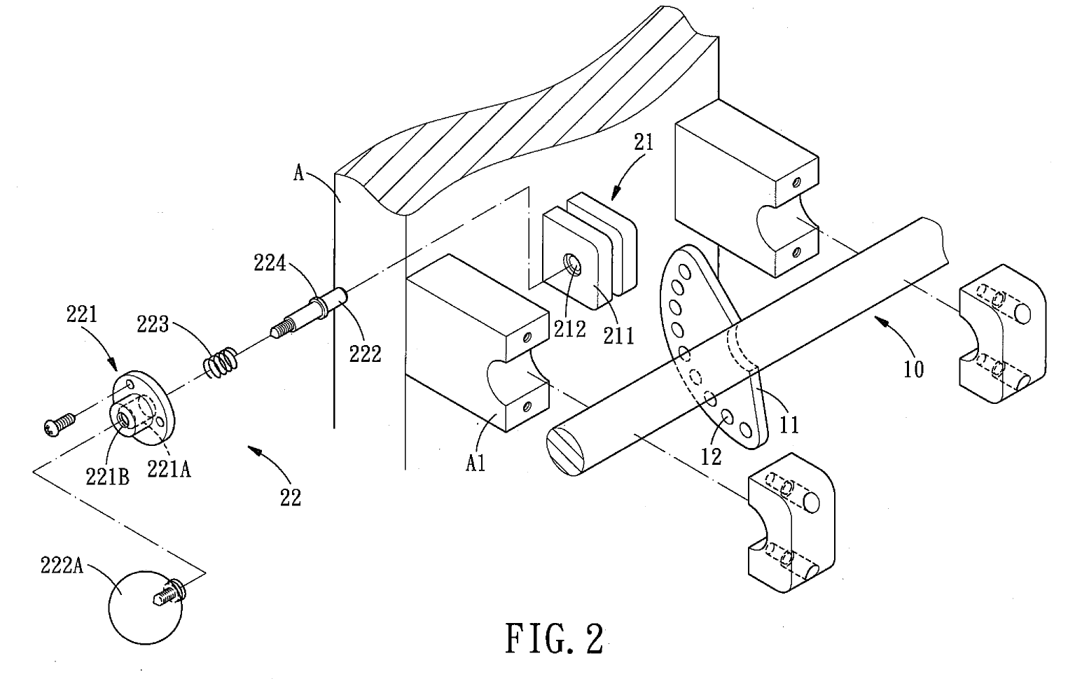

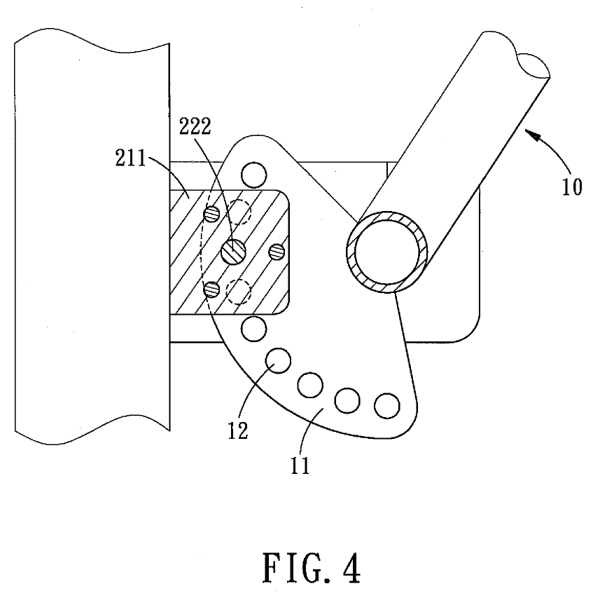

Referring to FIGS. 2-4, an adjustable handlebar assembly for a stand in accordance with the present invention can be installed on a handcart, a stretcher, or a hammock. The adjustable handlebar assembly is mounted on a stand A and comprises: a handlebar 10 and a positioning assembly 20.

The handlebar 10 is pivotally and rotatably mounted on two retaining members A1 at both sides of the stand A. A positioning member 11 is formed on the handlebar 10 and located between the two retaining members A1, and on the positioning member 11 is formed at least one positioning portion 12. In this embodiment, the positioning member 11 is sheet-shaped and extends radially outward from the handlebar 10. The positioning portions 12 are in the form of through holes located around the handlebar 10.

The positioning assembly 20 is mounted on the stand A by cooperating with the positioning member 11 of the handlebar 10 and includes: a positioning seat 21 and a limit subassembly 22 disposed on the positioning seat 21. The positioning seat 21 and the limit member 22 are located correspondingly to the positioning portions 12 of the positioning member 11 of the handlebar 10. In this embodiment, the positioning seat 21 includes two stopping pieces 211 located at both sides of the positioning member 11 of the handlebar 10, respectively. Each of the stopping pieces 211 is defined with a through hole 212 for cooperating with the positioning portions 12 of the positioning member 11 of the handlebar 10. The limit subassembly 22 includes a bearing seat 221, a control rod 222 and a spring 223. The bearing seat 221 is mounted on an outer surface of one of the stopping pieces 211 of the positioning seat 21 and is defined with a receiving groove 221A to be aligned with the through hole 212 of the stopping piece 211, and in the bottom of the receiving groove 221A is defined a hole 221B. A flange 224 is formed at a first end of the control rod 222 that is inserted in the through holes 212 of the two stopping pieces 211 and one of the positioning portions 12 of the positioning member 11 of the handlebar 10. The second end of the control rod 222 is inserted in the spring 223 and the hole 221B of the bearing seat 221, respectively, and a gripping member 222A is fixed at the second end of the control rod 222. The spring 223 is inserted on the control rod 222 and received in the receiving groove 221A of the bearing seat 221. The spring 223 is restricted between the flange 224 and the bearing seat 221 to provide a pushing force for pushing the control rod 222 toward the positioning member 11 of the handlebar 10. The flange 224 is larger than the through holes 212 of the stopping pieces 211.

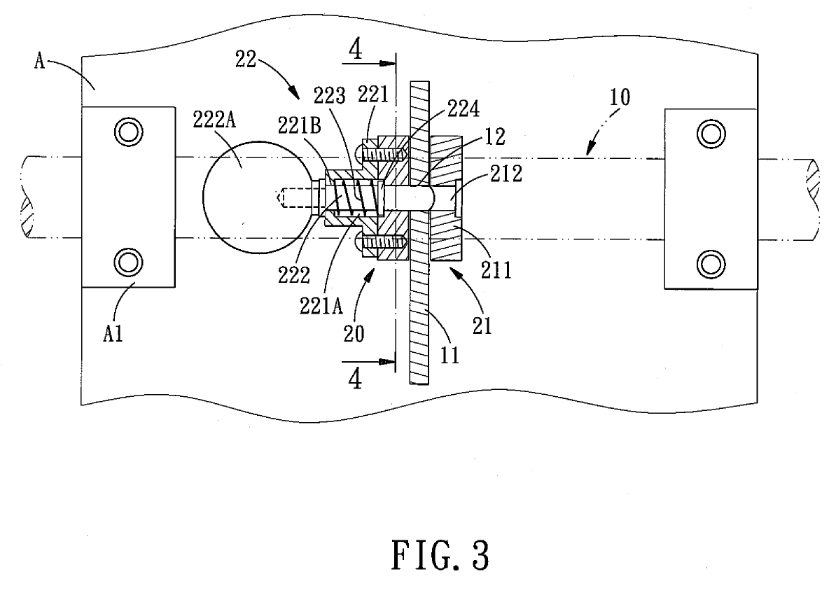

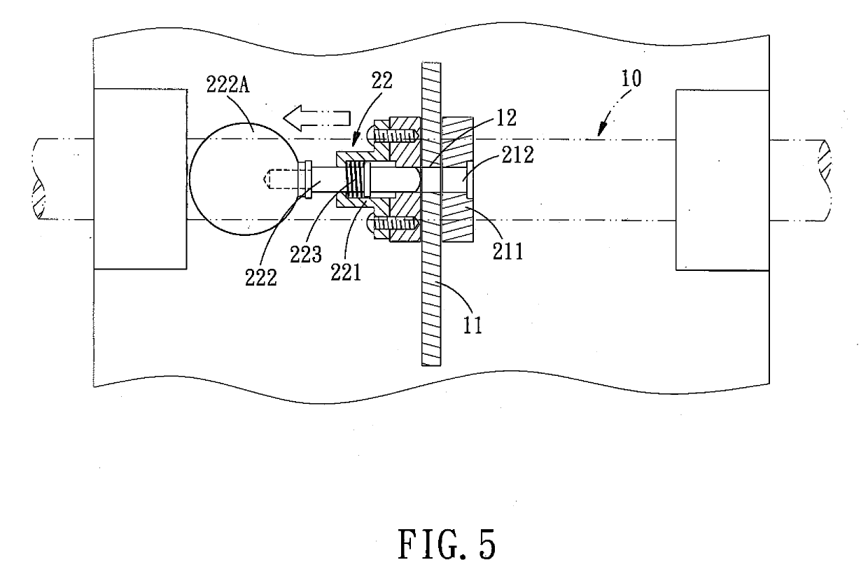

As shown in FIG. 3, the control rod 222 of the limit subassembly 22 of the positioning assembly 20 is inserted in the positioning portion 12 of the positioning member 11 of the handlebar 10. To adjust the operation angle of the handlebar 10, as shown in FIG. 5, the control rod 222 can be pulled out in the direction opposite the positioning member 11 of the handlebar 10 to disengage the handlebar 10 from the positioning assembly 20, and then the handlebar 10 can be rotated to adjust its operation angle. When pulling out the control rod 222 to release the handlebar 10, the spring 223 will be compressed. Therefore, when the handlebar 10 is adjusted to a desired angle and the control rod 222 is released from the fixed position, the spring 223 will use its compression force to push the control rod 222 into one of the positioning portions 12 of the positioning member 11 to position the handlebar 10.

It is apparent from above that the adjustable handlebar assembly of the present invention utilizes the positioning assembly 20 to position the rotatable handlebar 10, allowing the user to adjust the operation angle of the handlebar 10 according to his own stature and habit.

While we have shown and described various embodiments in accordance with the present invention, it is clear to those skilled in the art that further embodiments may be made without departing from the scope of the present invention.

What is claimed is:

1. An adjustable handlebar assembly for a stand, comprising:
a handlebar pivotally mounted on the stand and provided with a positioning member, the positioning member being formed with at least one positioning portion; and
a positioning assembly being mounted on the stand by cooperating with the positioning member of the handlebar and including a positioning seat and a limit subassembly for cooperating with the positioning portion of the handlebar to position the handlebar.

2. The adjustable handlebar assembly for a stand as claimed in claim 1, wherein the positioning member of the handlebar is defined with a plurality of positioning portions located around the handlebar.

3. The adjustable handlebar assembly for a stand as claimed in claim 1, wherein the positioning portion of the positioning member of the handlebar is in the form of a through hole, the limit subassembly of the positioning assembly includes a control rod which is extensible and retractable with respect to the positioning portion and cooperates with the positioning seat to position the handlebar.

4. The adjustable handlebar assembly for a stand as claimed in claim 3, wherein the positioning member of the handlebar is defined with a plurality of positioning portions located around the handlebar.

5. The adjustable handlebar assembly for a stand as claimed in claim 3, wherein the positioning seat includes two stopping pieces located at both sides of the positioning member of the handlebar, and each of the stopping pieces is defined with a through hole for cooperating with the positioning portion of the positioning member and the control rod of the handlebar.

6. The adjustable handlebar assembly for a stand as claimed in claim 3, wherein the limit subassembly includes a bearing seat and a spring to be inserted on the control rod, respectively, the bearing seat is mounted on the positioning seat, a flange is defined on the control rod and located between the bearing seat and the positioning member, so that, with the elastic force of the spring, the control rod is elastically extensible and retractable with respect to the positioning portion.
